(19) United States
(12) Patent Application Publication
(10) Pub. No.: US 2014/0265710 A1
(43) Pub. Date: Sep. 18, 2014

(54) COIL ARRANGEMENT WITH INTERMEDIARY WIRE TIE-OFF

(71) Applicant: REMY TECHNOLOGIES LLC, Pendleton, IN (US)

(72) Inventors: Chad Zook, Anderson, IN (US); Scott Bitzer, Fishers, IN (US)

(73) Assignee: REMY TECHNOLOGIES LLC, Pendleton, IN (US)

(21) Appl. No.: 13/829,387

(22) Filed: Mar. 14, 2013

(51) Int. Cl. H02K 3/00; H02K 15/02

(52) U.S. Cl. CPC H02K 3/00; H02K 15/022
USPC 310/195; 29/598; 310/272

(57) ABSTRACT

A coil arrangement for an electric machine comprises a spool including a hub, a first wall positioned on a first side of the hub, and a second wall positioned on a second side of the hub. A length of wire is wound on the hub to form a coil positioned between the first wall and the second wall of the spool. The coil includes a plurality of winding layers including an inner winding layer, an outer winding layer, and at least one intermediate winding layer between the inner winding layer and the outer winding layer. A projection is connected to the spool. The projection includes a first end directly connected to the spool and a second end opposite the first end, the second end is positioned between the first wall and the second wall of the spool. The outer winding layer engages the second end of the projection.

### FIELD

This application relates to the field of electric machines, and particularly to coils used in electric machines.

### BACKGROUND

Electro-mechanical machines are widespread. Rotating electro-mechanical machines, including generators, alternators and motors, are particularly prevalent, in vehicle applications. Rotating electromechanical machines usually include a stationary member, known as a “stator,” about which a rotating member, known as a “rotor,” turns. In certain types of machines, the rotor (sometimes referred to as an “armature”) rotates within the stator (or “field”), which produces a rotating magnetic field. In other types of machines, the rotor produces a magnetic field, which produces an electrical current in the stator. Both stators and rotors may include one or more windings of conductors (for example, field windings) that carry current and/or generate magnetic fields and forces.

Several different rotating electro-mechanical machine designs exist. One common design is the Lundell, or “claw-pole,” design. The claw-pole design is often used for alternators in vehicle applications. In a claw-pole alternator, the rotor includes two opposing claw-shaped pole segments positioned on opposite sides of a field winding that is wound upon a spool. Each pole segment has claw-shaped magnetic poles that extend in an axial direction from an end ring or disc and intermesh with poles from the opposite pole segment. These intermeshing claw-pole segments surround the field winding. The field winding is wound upon a spool such that the field winding encircles the rotor axis (which is coaxial with the spool axis). When current flows through the field winding, one of the claw-pole segments provides a magnetic north segment and the other provides a magnetic south segment. Thus, the interlaced fingers of the claw-pole configuration results in a rotor with an alternating N pole/S pole arrangement. Rotation of the rotor provides a rotating magnetic field. This rotating magnetic field induces a voltage in the stator windings. The magnetic field in the stator rotates at the same speed, or synchronously, with the rotor field. The stator windings are connected to a rectifier, which converts the AC stator output to a DC output. A voltage regulator monitors the system voltage and adjusts the output of the alternator by controlling the current through the field coil.

It is desirable for the field winding in a claw-pole electric machine to have a mounded coil in an attempt to achieve a high rotor fill. A high rotor fill helps improve performance and efficiency of the electric machine. A mounded coil is provided when more layers of central windings are provided on the coil than lateral windings. In this case, the central windings of the coil are built up to provide an apex on the coil while the lateral windings remain closer to the hub of the spool because there are fewer layers of lateral windings. Typically, the mounded coil provides a gradual height transition of the outer windings with the outer center winding being the highest winding above the hub of the spool and the left and right lateral windings being the lowest in height above the spool.

When winding a mounded winding on a spool, the outer central winding often has some slack. The reason for this is that the final wind is centrally located on the coil but must be tied off at a side post. Thus, when the final outer central winding ends, it is routed to the side post, and unwanted slack results in the central outer winding. This slack is undesirable as it reduces the effective rotor fill. Furthermore, the slack in the outer central winding results in a loose winding that is subject to damage during manufacture or operation of the rotor as a result of moving parts.

In view of the foregoing, it would be desirable to provide a rotor with a mounded coil having a high rotor fill. Furthermore, it would be desirable to produce such a mounded coil having a central winding with reduced slack. It would also be desirable if such a mounded coil could be easily produced with relatively little additional manufacturing expense.

### SUMMARY

In accordance with at least one embodiment of the disclosure, a coil arrangement for an electric machine comprises a spool including a hub, a first wall positioned on a first side of the hub, and a second wall positioned on a second side of the hub. A length of wire is wound on the hub to form a coil positioned between the first wall and the second wall of the spool. The coil includes a plurality of winding layers including an inner winding layer, an outer winding layer, and at least one intermediate winding layer between the inner winding layer and the outer winding layer. A projection is connected to the spool. The projection includes a first end directly connected to the spool and a second end opposite the first end, with the second end positioned between the first wall and the second wall of the spool. The outer winding layer engages the second end of the projection.

In accordance with another embodiment of the disclosure, there is provided a method of manufacturing a rotor for an electric machine. The method includes winding a length of wire on a spool to form a coil, with the coil positioned between a first wall and an opposing second wall of the spool. The method further includes coupling a final winding of the coil to a first tie-off member positioned in a central location between the first wall and the second wall of the spool. Additionally, the method includes extending the wire from the first tie-off member to a second tie-off member positioned on a sidewall of the spool.

Pursuant to yet another embodiment of the disclosure, there is provided a spool configured to receive a coil for an electric machine. The spool includes a hub defining an axial direction and a radial direction. A first wall is positioned on a first side of the hub, and a second wall is positioned on a second side of the hub. A first tie-off member and a second tie-off member are connected to the spool. The first tie-off member includes a first end connected to the spool and a second end opposite the first end, with the second end positioned between the first wall and the second wall of the spool radially outward from the hub. The second tie-off member includes a first end directly connected to the spool and a second end opposite the first end, the second end positioned radially outward from the first wall or the second wall of the spool.

The above described features and advantages, as well as others, will become more readily apparent to those of ordinary skill in the art by reference to the following detailed description and accompanying drawings. While it would be desirable to provide coil arrangement for an electric machine that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a cross-section of an electric machine including a rotor with a winding arrangement having an intermediary wire tie-off post;

FIG. 2 shows a perspective view of the rotor of FIG. 1;

FIG. 3 shows a side view of a winding arrangement for the rotor of FIG. 2;

FIG. 4A shows a perspective view of the spool of the winding arrangement of FIG. 3;

FIG. 4B shows an enlarged view of the intermediary wire tie-off post for the spool of FIG. 4A;

FIG. 5 shows a front view of the spool of FIG. 4A;

FIG. 6 shows a top view of the intermediary wire tie-off post for the spool of FIG. 4A;

FIG. 7 shows a perspective view of the winding arrangement of FIG. 3 with the tabs of the spool pivoted radially inward and an end lead extending from the tie-off members on the spool;

FIG. 8 shows a block diagram of a method of making a winding arrangement including a spool with an intermediary wire tie-off post; and

FIG. 9 shows a side view of an alternative embodiment of a winding arrangement for the rotor of FIG. 2.

### DESCRIPTION

With reference to FIG. 1, an electric machine is shown in the form of a claw-pole alternator 10. The alternator includes a stator assembly 12 and a rotor assembly 14 positioned within a housing 16. The rotor assembly includes two claw-pole segments 40, 42 connected to a shaft 18. As is well known in the art, the shaft 18 is driven by a belt (not shown) during operation of the vehicle in which the alternator 10 is mounted. As explained in further detail below, a field coil 102 with increased rotor fill is positioned within the claw-pole segments 40, 42.

The stator assembly 12 is stationary within the alternator housing 16. The stator assembly 12 includes a stator core 20 and stator windings 22. The stator core 20 includes a plurality of teeth that extend radially inward from the outer diameter of the stator core. The stator windings 22 are retained by slots formed between the teeth of the stator core. The stator windings 22 may be formed by insulated copper wires that form coils that wrap around the stator core. The coils are separated into three distinct winding segments that provide a three-phase electrical output for the alternator 10.

The rotor assembly 14 is rotatably positioned inside of the stator 12 within the alternator 10. The rotor assembly 14 is separated from the stator 12 by an airgap 24 in an active air-gap region 46 of the rotor. The rotor assembly 14 includes an iron core 30, a field coil 102, and two claw-pole segments 40, 42. In the disclosed embodiment, the field coil 102 is wound around a spool 110, and the spool 110 is connected to the claw-pole segments 40, 42. The first claw-pole segment 40 and the second claw-pole segment 42 surround the spool 110 and the associated field coil 102. The two claw-pole segments 40, 42 and the rotor core 30 are all secured to the shaft 18. Accordingly, the iron core 30, the first claw-pole segment 40 and the second claw-pole segment 42, the spool 110 and the field coil 102 are all rotatable with the shaft 18 within the alternator housing 16.

FIG. 2 shows a perspective view of the rotor assembly 14, including first and second claw pole segments 40, 42 and the field coil 102. The field coil 102 is a mounded coil that includes more layers of central windings than lateral windings, as explained in further detail below. The first claw pole segment 40 is substantially similar to the second claw pole segment 42. The second claw pole segment 42 is generally crown shaped and includes a hub 60, an end face 62, and a plurality of fingers 64 extending from the end face 62. Knuckle portions 66 join the fingers 64 to the end face 62. In the embodiment of FIG. 2, the knuckle portions 66 are generally enlarged portions on the finger 64 and each finger is tapered in an axial direction away from the end face 62. Recesses 68 are formed between the knuckles 66 on the end face 62 of the claw-pole segment 42. Each finger 64 of the claw-pole segment 42 includes an exterior side 70 that faces the stator assembly 12, an interior side 72 that faces the field winding 34, a distal end 74 that is furthest from the associated end face 62, and a proximal end 76 that is fixedly connected to the end face 62.

FIG. 3 shows a coil arrangement 100 for the rotor assembly 14 including the field coil 102 and the spool 110. The field coil 102 is shown in cross-section in FIG. 3 to illustrate the arrangement of the coil windings 104 on the spool 110, while the spool 110 is shown as a side view. As explained in further detail below, the spool 110 includes a projection 150 configured to serve as a tie-off member for the field coil 102.

The field coil 102 is formed by a length of wire 108 wound on the spool 110 to form the coil 102. The wire 108 may be comprised of copper or other conductive material as will be recognized by those of ordinary skill in the art. The field coil 102 includes a plurality of coil windings 104 provided in a plurality of layers 106 to form a mounded coil. In particular, the coil 102 includes more layers 106 of central coil windings than lateral coil windings (i.e., the wire 108 wraps around the central portion of the hub 112 of the spool 110 more times than at the lateral portions of the spool). Accordingly, as shown in FIG. 3, the outermost central coil winding 104c is a greater distance from a hub 112 of the spool 110 than the outermost left lateral coil winding 104a and the outermost right lateral coil winding 104b. Additionally, the winding layers 106 include an inner winding layer 106a, an outer winding layer 106c, and at least one intermediate winding layer 106b between the inner winding layer and the outer winding layer.

The spool 110 is generally comprised of a lightweight and rigid material such as nylon, PVC or other polymer. As best shown in FIGS. 3-5, the spool 110 includes a cylindrical hub 112, a first wall 120, and a second wall 140. The hub 112 includes a substantially smooth winding surface 114 and a substantially smooth interior surface 116. The cylindrical shape of the hub is defined by a radius r (a distance from the axis 118) and a height h. The first wall 120 is positioned on a first side of the hub 112 and the second wall 140 is positioned on a second opposing side of the hub 112. The height h of the cylindrical hub is the distance between the first wall 120 and the second wall 140.

The first wall 120 extends outward from the hub 112 in a generally radial direction on the first side of the hub 112. The first wall 120 includes a circular portion 122 connected to the hub 112 and a plurality of tab members 130 connected to the circular portion 122. The circular portion 122 is defined between an inner perimeter 124 and an outer perimeter 126. The inner perimeter 124 of the circular portion 122 is connected to and extends completely around the first side of the hub 112. The circular portion 122 extends radially outward from the inner perimeter 124 until it reaches the outer perimeter 126. A smooth disc-shaped interior surface 128 is provided between the inner perimeter 124 and the outer perimeter 126 of the circular portion 122. A plurality of protuberances 129 extend axially outward from the circular portion 122. As best shown in FIG. 2, these protuberances 129 are configured to extend into the recesses 68 of the claw pole segments 40, 42, and lock the spool 110 in place relative to the claw-pole segments 40, 42.

With reference again to FIGS. 3-5, the tab members 130 are pivotably connected to the circular portion 122 along the outer perimeter 126 of the circular portion 122. The tab members 130 are generally parabolic in shape and include a flared base portion 132 and a curved nose 134. Each flared base portion 132 is pivotably connected to the circular portion 122 along a living hinge 136. Vent holes 138 are provided in each base portion 132 to allow heat to escape the windings through the vent holes 138.

The second wall 140 is substantially identical to the first wall 120, and therefore the second wall 140 is not explained in detail herein. While the second wall 140 is substantially identical to the first wall 120, a few distinctions exist between the two walls. For example, as best shown in FIGS. 4A and 5, the tab members 130 on the first wall 120 are staggered from the tab members on the second wall 140 in the circumferential direction. Additionally, as explained in the following paragraphs, two different projections are provided on the opposing first wall 120 and second wall 140 of the spool 110 and serve as tie-off members for the winding on the spool 110.

With particular reference to FIGS. 4A and 4B, the two tie-off members on the spool 110 include a first tie-off post 150 located on the first wall 120 and a second tie-off post 160 located on the second wall 140. The first tie-off post 150 is provided by a projection that extends radially outward from the spool 110 on the first wall 120. The first tie-off post 150 includes a first end 152 and a second end 154 opposite the first end 152. The first end 152 is directly connected to the spool by a living hinge 156. The second end 154 of the first tie-off post 150 is free from contact with other portions of the spool 110 including the hub. The living hinge 156 allows the first tie-off post 150 to pivot between a first position where it extends radially outward from the spool 110 on the first wall 120 (see FIG. 4A) and a second position where it extends substantially axially inward on the spool 110 on the first wall 120 (see FIG. 7). In the first position, the second end 154 of the tie-off post 150 is located radially outward from the first wall 120. In the second position, as shown in FIG. 7, the second end 154 of the tie-off post is positioned between the first wall 120 and the second wall 140 in the axial direction. The second end 154 of the first tie-off post includes a hook member 158. The hook member 158 is designed and dimensioned such that the wire that forms the coil 102 of the winding arrangement 100 can be received in the curved portion of the hook member 158 and then wrapped around the hook member 158 in order to securely anchor the end lead of the coil 102 after the coil is formed on the spool 110.

The second tie-off post 160 is positioned on the second wall 140. The second tie-off post is fixedly connected to the second wall 140 and is not pivotable. The second tie-off post 160 extends in a radially outward direction from the spool 110 on the second wall 140. The second tie-off post 160 is generally mushroom shaped and includes a first end 162 that serves as the stem and a second end 164 that serves as the head. The first end 162 is directly connected to the second wall 140 of the spool. The second end 164 is connected to the first end 162 but is not otherwise directly connected to the spool 110. The second tie-off post 160 is designed and dimensioned such that the wire 108 providing the end lead for the coil 102 of the winding arrangement 100 can be wrapped around the first end 162 of the second tie-off post in order to secure the end lead of the coil 102 to a non-pivotable member after the coil 102 is formed on the spool 110.

As discussed previously, and shown in FIG. 3, the outermost central winding 104c is a greater distance from a hub 112 of the spool 110 than the left lateral windings 104a and the right lateral windings 104b. With particular reference to FIG. 7, the outermost central winding 104c engages and wraps around the second end 154 of the first tie-off post 150. From this position, the length of wire 108 that forms the coil is extended to the second tie-off post 160 and wraps around the second tie-off post 160. A tight tension is maintained on the wire 108 between the first tie-off post 150 and the second tie-off post 160 to maintain a tight tension on the coil with little slack. From the second tie-off post 160, the wire 108 extends away from the spool 110 to provide an end lead 109 for the coil 102. While not shown in the figures, it will be recognized that the coil 102 also includes a start lead that extends along one of the sidewalls 120 or 140 and to the hub 112 where the coil begins at the inner winding layer. Accordingly, the start lead for the coil 102 extends from the coil along one of the sidewalls 120 or 140, and the end lead 109 for the coil 102 extends from the second tie-off post 160.

Once the coil 102 is formed on the spool 110 and the end lead is coupled to the first and second tie-off posts 150, 160, the tab members 130 on the first wall 140 and the second wall are folded inward over the coil 102 hub 112 of the spool 110. The folded tab members 130 are contoured and positioned around the spool 110 such that the perimeter of the tab members 130 substantially matches the perimeter of the fingers 64 of the claw-pole segments 40, 42. Accordingly, the tab members 130 are substantially covered by the fingers 64 of the claw-pole segments 40, 42 when the winding arrangement 100 is assembled inside of the rotor 14, as shown in FIG. 2. The protuberances 129 from the spool 110 extend into the recesses 68 between the fingers 64 to secure the spool 110 in place relative to the claw-pole segments 40, 42.

With reference now to FIG. 8 a method 800 of winding a coil is disclosed. The method begins with step 802 where a length of wire is wound on a spool in layers between two sidewalls of the spool. The length of wire begins with a start lead that begins at a point away from the spool and extends to the hub of the spool. Thereafter, the wire is wound around the hub of the spool multiple times to form windings on the spool. In step 804, the windings of the coil form a mounded coil with a central outer winding that is further from the hub of the spool than the left and right lateral outer windings. Next, in step 806, a tie-off post is pivoted from a sidewall of the spool to a central position between the two sidewalls of the spool. In step 808, the central outer winding is secured to the centrally located tie-off post by wrapping the central outer winding to the tie-off post. As discussed previously, the centrally located tie-off post may include a hook portion, and the central outer winding may be wrapped around this hook. When this is done, the pivoted tie-off post is retained in place by coupling of the wire and the hook portion at a central location on the spool. Moreover, when the central outer winding is secured to the tie-off post at this central location, a tight tension is maintained on the outer central winding and the associated coil. Next, in step 810, the wire secured to the centrally located tie-off post is extended to a side tie-off post provided on one of the sidewalls of the spool. The wire is then wrapped around the side tie-off post to secure the wire to the spool. As a result, a length of the wire extends away from the side tie-off post to provide a lead for the coil. In step 812, once the coil is completed on the spool, the tabs on the spool are bent inward and the winding arrangement is positioned between opposing claw-pole segments to provide a rotor arrangement such as that shown in FIG. 2.

With reference now to FIG. 9 one alternative embodiment of the coil arrangement is shown. In this embodiment the first tie-off member is provided by a first tie-off post 150a that is connected directly to the hub 112 of the spool 110 and extends radially outward from the hub 112. The first tie-off post 150a may be integrally formed with the hub 112 during the molding process. In this embodiment, the first tie-off post 150a includes a first end 152a that is fixedly connected to a center location on the hub 112 between the first wall 120 and the second wall 140. The second end 154a of the first tie-off post 150a is positioned above the surface of the hub 112 between the first wall 120 and the second wall 140. The second end 145a of the first tie-off post 150a also includes a hook portion 156a. When the coil 102 is wound on the spool, the wire 108 that forms the coil 102a is simply wound past the first tie-off post 105a on the inner and intermediate layers of windings. As shown in FIG. 9, the coil 102 may be a mounded coil such that the outer layer of windings are different distances from the hub resulting from more intermediate winding layers near the center than at the sides of the hub. For example, as shown in FIG. 9, the coil 102 may include six winding layers near the center of the coil, but only two or three winding layers at the sides of the coil. As a result, the outer center winding 104c of the coil is a greater distance from the hub 112 than the outer side windings 104a and 104b of the coil 102. With these mounded coils, a tie-off member positioned near the centerline of the spool 110 is useful since the centerline 119 of the spool (i.e., a line extending through the midpoint of the height h shown on the spool in FIG. 3) is generally the location where the final wind (i.e., the outer central winding 104c) on the coil 102a is completed. The outer central winding 104c is pulled tight to remove slack in the coil 102a, wrapped around the hook 156a in the winding post 105a, and the wire 108 is then routed to the second tie-off post 160a on the side of the spool 110. By providing a tie-off post for the final wind at the centerline 119 of the spool 110, the highest rotor fill possible may still be achieved for the mounded coil 102a without the need to introduce slack into the coil at the final winding. In particular, as explained above, this is achieved by routing the coil wire at the final winding from the centrally located first tie-off member to the second tie-off member located at the side of the spool.

The foregoing detailed description of one or more embodiments of the coil arrangement with intermediary wire tie-off for claw-pole electric machines has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A coil arrangement for an electric machine, the coil arrangement comprising:
a spool including a hub, a first wall positioned on a first side of the hub, and a second wall positioned on a second side of the hub;
a length of wire wound on the hub to form a coil positioned between the first wall and the second wall of the spool, the coil including a plurality of winding layers including an inner winding layer, an outer winding layer, and at least one intermediate winding layer between the inner winding layer and the outer winding layer; and
a projection connected to the spool, the projection including a first end directly connected to the spool and a second end opposite the first end, the second end positioned between the first wall and the second wall of the spool, the outer winding layer engaging the second end of the projection.

2. The coil arrangement of claim 1 wherein the first end of the projection is connected to the hub between the first wall and the second wall.

3. The coil arrangement of claim 1 wherein the first end of the projection is connected to the first wall.

4. The coil arrangement of claim 3 wherein the first end of the projection is pivotably connected to the first wall and the second end of the projection is retained in place by engagement with the length of wire.

5. The coil arrangement of claim 1 wherein the second end of the projection is free from contact with other portions of the spool including the hub, the first wall and the second wall.

6. The coil arrangement of claim 1 wherein the second end of the projection includes a hook and the outer winding layer engages the hook.

7. The coil arrangement of claim 1 wherein the first wall includes a plurality of bendable radial tabs extending from the first wall toward the second side of the hub.

8. The coil arrangement of claim 1 wherein the coil arrangement is positioned within claw-pole segments of a rotor of the electric machine.

9. A method of manufacturing a rotor for an electric machine, the method comprising:
winding a length of wire on a spool to form a coil, the coil positioned between a first wall and an opposing second wall of the spool;
coupling a final winding of the coil to a first tie-off member positioned in a central location between the first wall and the second wall of the spool; and
extending the wire from the first tie-off member to a second tie-off member positioned on a sidewall of the spool.

10. The method of claim 9 further comprising pivoting the first tie-off member to the central location between the first wall and the second wall of the spool before coupling the final winding of the coil to the first tie-off member.

11. The method of claim 9 wherein winding the length of wire on the spool includes winding the length of wire on the spool to form a mounded coil.

12. The method of claim 9 wherein coupling the final winding of the coil to the first tie-off member includes wrapping the length of wire around a hook on the first-tie-off member.

13. The method of claim 9 further comprising positioning the coil and spool within two claw-pole segments of the rotor.

14. The method of claim 9 wherein winding the length of wire on the spool to form the coil includes winding the length of wire around a hub of the spool with the first tie-off member connected to the hub.

15. A spool configured to receive a coil for an electric machine, the spool comprising:
a hub defining an axial direction and a radial direction;
a first wall positioned on a first side of the hub, and a second wall positioned on a second side of the hub;
a first tie-off member connected to the spool, the first tie-off member including a first end connected to the spool and a second end opposite the first end, the second end positioned between the first wall and the second wall of the spool radially outward from the hub; and
a second tie-off member connected to the spool, the second tie-off member including a first end directly connected to the spool and a second end opposite the first end, the second end positioned radially outward from the first wall or the second wall of the spool.

16. The spool of claim 15 wherein the first end of the first tie-off member is connected to the first wall or the second wall of the spool, the first tie-off member pivotable between a first position and a second position, the second end of the first tie-off member positioned between the first wall and the second wall of the spool radially outward from the hub when in the first position, and the second end of the first tie-off member positioned radially outward from the first wall or the second wall of the spool when in the second position.

17. The spool of claim 16 wherein a living hinge connects the first tie-off member to the first wall or the second wall of the spool.

18. The spool of claim 15 wherein the first end of the first tie-off member is connected to the hub of the spool.

19. The spool of claim 15 wherein the second end of the first tie-off member includes a hook configured to engage a length of wire wound upon the spool.

20. The spool of claim 15 wherein the first tie-off member and the second tie-off member are projections extending from the first wall or the second wall of the spool.
